(19) United States
(12) Patent Application Publication
(10) Pub. No.: US 2017/0155889 A1
(43) Pub. Date: Jun. 1, 2017

(54) IMAGE CAPTURING DEVICE, DEPTH INFORMATION GENERATION METHOD AND AUTO-CALIBRATION METHOD THEREOF

(71) Applicant: Altek Semiconductor Corp., Hsinchu City (TW)

(72) Inventors: Young-Fei Chien, Hsinchu City (TW); Yu-Chih Wang, Hsinchu City (TW); Hong-Long Chou, Hsinchu City (TW); Che-Lun Chuang, Hsinchu City (TW); Yao-Sheng Wang, Hsinchu City (TW)

(21) Appl. No.: 15/015,141

(22) Filed: Feb. 4, 2016

Related U.S. Application Data
(60) Provisional application No. 62/260,645, filed on Nov. 30, 2015.

(30) Foreign Application Priority Data
Dec. 30, 2015 (TW) 104144379

(51) Int. Cl. H04N 13/02; H04N 13/04; G06T 7/00

(52) U.S. Cl. CPC H04N 13/0246; H04N 13/0239; G06T 7/0018; G06T 7/0075; H04N 13/0275; H04N 13/0425; H04N 13/0271; G06T 2207/10012

(57) ABSTRACT

An image capturing device, a depth information generation method and an auto-calibration method thereof are provided. The methods are adapted to an image capturing device having dual lens without pre-alignment and include the following steps. A scene is captured by using the dual lens to generate a first image and a second image. First feature points and second feature points are respectively detected from the two images to calculate pixel offset information between the two images, and a rotation angle between the two images are obtained accordingly. An image warping process is performed on the two images according to the pixel offset information and the rotation angle to generate a first reference image and a second reference image aligned with the first reference image. Depth information of the scene is calculated or a stereoscopic image is generated according to the first reference image and the second reference image.

### CROSS-REFERENCE TO RELATED APPLICATION

This application claims the priority benefit of U.S. provisional application Ser. No. 62/260,645, filed on Nov. 30, 2015, and Taiwan application serial no. 104144379, filed on Dec. 30, 2015. The entirety of each of the above-mentioned patent applications is hereby incorporated by reference herein and made a part of this specification.

### TECHNICAL FIELD

The disclosure is related to an image capturing device, in particular, to an image capturing device, a depth information generation method and an auto-calibration method thereof.

### BACKGROUND

With development in technology, various smart mobile electronic devices, such as tablet computers, personal digital assistants and smart phones, have become indispensable tools for people nowadays. Camera lenses equipped in high-end smart mobile electronic devices provide same or better specifications than those of traditional consumer cameras, and some even provide three-dimensional image capturing features or near-equivalent pixel qualities to those of digital single lens reflex cameras.

In general, dual lenses of an image capturing device are hardly to be disposed precisely at predetermined positions during manufacture. Hence, the disposed dual-lenses module would be tested and calibrated to obtain factory preset parameters at this stage. Thus, while the user is using such image capturing device, images captured by the dual lenses would be calibrated based on the factory preset parameters to overcome the lack of precision in the manufacture.

However, the testing and calibrating procedures would result in a huge amount of manufacturing cost. Moreover, in practical use, spatial offsets such as displacement or rotation usually occur on the dual lenses due to external factors such as drop-offs, bumps, squeezes, changes in temperatures or humidity. Once displacement or rotation occurs on the dual lenses, the factory preset parameters would no longer be valid, and the image capturing device would not be able to obtain accurate depth information. For example, when the dual lenses are not horizontally balanced, left and right images captured thereby would not be horizontally matched and would produce an unsatisfactory three-dimensional image capturing result.

### SUMMARY OF THE INVENTION

Accordingly, the disclosure is directed to an image capturing device, a depth information generation method and an auto-calibration method thereof, where depth information of a captured scene and an auto-calibrated stereoscopic image would be generated in real time without pre-alignment by a module manufacturer.

A depth information generation method of an image capturing device is provided in the disclosure. The method is adapted to an image capturing device having a first lens and a second lens without pre-alignment and includes the following steps. First, a scene is captured by using the first lens and the second lens to respectively generate a first image and a second image of the scene. First feature points and second feature points are respectively detected from the first image and the second image to calculate pixel offset information of the first image and the second image, and a rotation angle between the first image and the second image is obtained accordingly. Image warping is performed on the first image and the second image according to the pixel offset information and the rotation angle to respectively generate a first reference image and a second reference image aligned with each other. Depth information of the scene is calculated according to the first reference image and the second reference image.

An auto-calibration method of an image capturing device is also provided in the disclosure. The method is adapted to an image capturing device having a first lens and a second lens without pre-alignment and includes the following steps. First, a scene is captured by using the first lens and the second lens to respectively generate a first image and a second image of the scene. First feature points and second feature points are respectively detected from the first image and the second image to calculate pixel offset information of the first image and the second image, and a rotation angle between the first image and the second image is obtained accordingly. Image warping is performed on the first image and the second image according to the pixel offset information and the rotation angle to respectively generate a first reference image and a second reference image aligned with each other. A stereoscopic image of the scene is generated according to the first reference image and the second reference image.

According to an embodiment of the disclosure, the step of detecting the first feature points and the second feature points respectively from the first image and the second image to calculate the pixel offset information between the first image and the second image includes to detect feature points from the first image and the second image, to compare each of the feature points in the first image and the second image to obtain feature point sets, and to obtain a pixel coordinate of each of the first feature points in the first image and a pixel coordinate of each of the second feature points in the second image to accordingly calculate the pixel offset information between the first image and the second image, where each of the feature point sets includes each of the first feature points and the second feature point corresponding to each of the first feature points.

According to an embodiment of the disclosure, the step of obtaining the rotation angle between the first image and the second image includes to calculate the rotation angle between the first image and the second image according to the pixel coordinates and the pixel offset information of each of the first feature points and each of the second feature points respectively in the first image and the second image.

According to an embodiment of the disclosure, the step of performing image warping on the first image and the second image according to the pixel offset information and the rotation angle to respectively generate the first reference image and the second reference image includes to calculate the pixel coordinates of at least one of the first image and the second image according to the pixel offset information and the rotation angle to respectively generate the first reference image and the second reference image.

According to an embodiment of the disclosure, the step of calculating the depth information of the scene according to the first reference image and the second reference image includes to perform three-dimensional depth estimation by using the first reference image and the second reference image to generate the depth information of the scene.

According to an embodiment of the disclosure, when a resolution of the first image is not the same as that of the second image, after the step of generating the first image and the second image of the scene, the method further includes to adjust at least one of the resolution of the first image and that of the second image so that the resolution of the first image becomes the same as that of the second image.

An image capturing device without pre-alignment by a module manufacturer is also provided, where the image capturing device includes a first lens, a second lens, a memory, and one or more processors. The memory is coupled to the first lens and the second lens and configured to store images captured by the first lens and the second lens. The processor is coupled to the first lens, the second lens, and the memory and includes multiple modules, where the modules include an image capturing module, a feature point detecting module, an image warping module, and an image processing module. The image capturing module is configured to capture a scene by using the first lens and the second lens to respectively generate a first image and a second image of the scene. The feature point detecting module is configured to detect first feature points and second feature points respectively from the first image and the second image to calculate pixel offset information between the first image and the second image, and to obtain a rotation angle between the first image and the second image accordingly. The image warping module is configured to perform image warping on the first image and the second image according to the pixel offset information and the rotation angle to respectively generate a first reference image and a second reference image aligned with each other. The depth calculating module is configured to calculate depth information of the scene according to the first reference image and the second reference image.

According to an embodiment of the disclosure, the image capturing device further includes an image adjusting module. When a resolution of the first image is not the same as that of the second image, the image adjusting module is configured to adjust at least one of the resolution of the first image and that of the second image so that the resolution of the first image becomes the same as that of the second image.

According to an embodiment of the disclosure, the image capturing device further includes a depth calculating module configured to calculate depth information of the scene according to the first reference image and the second reference image.

According to an embodiment of the disclosure, the first lens and the second lens have different optical characteristics or different resolutions.

According to an embodiment of the disclosure, the first lens and the second lens have same optical characteristics or same resolutions.

In summary, in the image capturing device, the depth information generation method and the auto-calibration method thereof proposed in the disclosure, after the image capturing device captures two images by using dual lenses, the two images are aligned according to pixel offset information and a rotation angle between the two images obtained through feature point detection, and depth information of a captured scene would be obtained and a stereoscopic image would be generated accordingly. The proposed image capturing device would generate depth information of captured scene and generate an auto-calibrated stereoscopic image in real time without pre-alignment by a module manufacturer so as to save up a huge amount of manufacturing cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a block diagram of an image capturing device according to an embodiment of the disclosure.

FIG. 2 illustrates a flowchart of a depth information generation method of an image capturing device according to an embodiment of the disclosure.

FIG. 3 illustrates a block diagram of an image capturing device according to another embodiment of the disclosure.

FIG. 4 illustrates a flowchart of an auto-calibration method of an image capturing device according to an embodiment of the disclosure.

FIG. 5 illustrates a functional block diagram of a depth information generation method and an auto-calibration method according to an embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. In addition, the specifications and the like shown in the drawing figures are intended to be illustrative, and not restrictive. Therefore, specific structural and functional detail disclosed herein are not to be interpreted as limiting, but merely as a representative basis for teaching one skilled in the art to variously employ the disclosure.

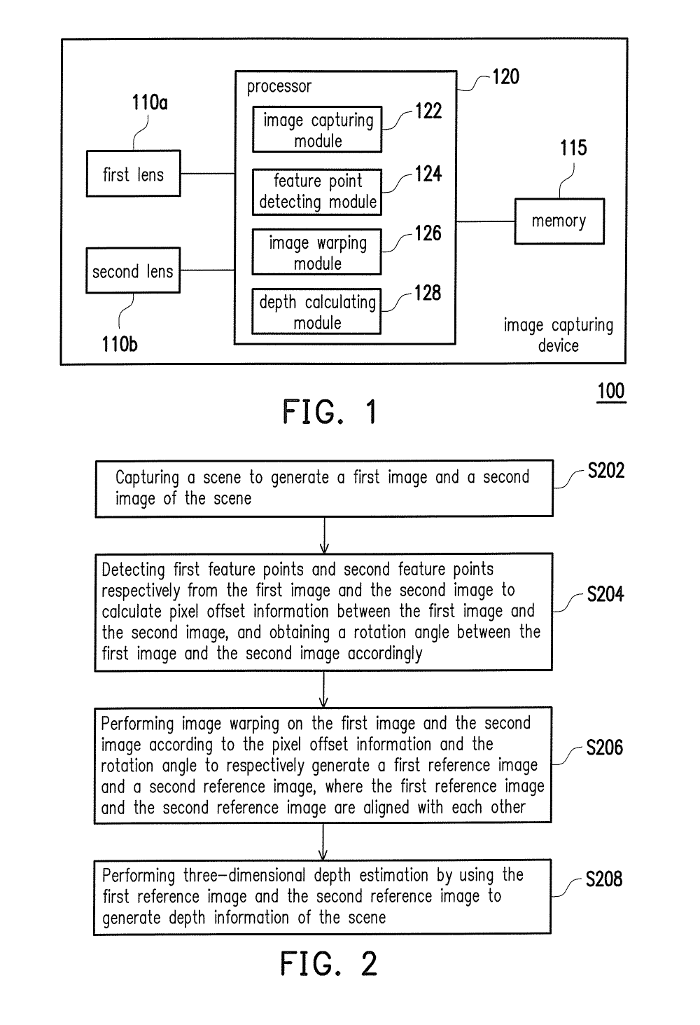

FIG. 1 illustrates a block diagram of an image capturing device according to an embodiment of the disclosure. It should, however, be noted that this is merely an illustrative example and the invention is not limited in this regard. All components of the image capturing device and their configurations are first introduced in FIG. 1. The detailed functionalities of the components are disclosed along with FIG. 2. The proposed image capturing device would generate depth information of a captured scene and generate an auto-calibrated stereoscopic image without pre-alignment by a module manufacturer so as to save up a huge amount of manufacturing cost.

Referring to FIG. 1, an image capturing device 100 includes a first lens 110a, a second lens 110b, a memory 115, and one or more processors 120. In the present embodiment, the image capturing device 100 may be a digital camera, a digital camcorder, a digital single lens reflex camera or other devices provided with an image capturing feature such as a smart phone, a tablet computer, a personal digital assistant, and so forth. The disclosure is not limited herein.

The first lens 110a and the second lens 110b include sensing elements for sensing light intensity entering the first lens 110a and the second lens 110b to thereby generate images. The optical sensing elements are, for example, charge-coupled-device (CCD) elements, complementary metal-oxide semiconductor (CMOS) elements, and yet the invention is not limited thereto. In the present embodiment, the first lens 110a and the second lens 110b are two lenses with same resolutions and same optical characteristics. However, in other embodiment, the first lens 110a and the second lens 110b may be two lenses with different resolutions or different optical characteristics such as focal lengths, sensing areas, and distortion levels. For example, the first lens 110a could be a telephoto lens, and the second lens 110b could be a wide-angle lens. Alternatively, the first lens 110a may be a higher resolution lens, and the second lens 110b may be a lower resolution lens.

The memory 115 may be one or a combination of a stationary or mobile random access memory (RAM), a read-only memory (ROM), a flash memory, a hard drive or other similar devices. The memory 115 is coupled to the first lens 110a and the second lens 110b for storing images captured thereby.

The processor 120 may be, for example, a central processing unit (CPU) or other programmable devices for general purpose or special purpose such as a microprocessor and a digital signal processor (DSP), a programmable controller, an application specific integrated circuit (ASIC), a programmable logic device (PLD) or other similar devices or a combination of above-mentioned devices. The processor 120 is coupled to the first lens 110a, the second lens 110b, and the memory 115, and includes, for example, an image capturing module 122, a feature point detecting module 124, an image warping module 126, and a depth calculating module 128 for performing generating depth information of images captured by the image capturing device 100. Detail steps of the depth information generation method performed by the image capturing device 100 would be illustrated by the embodiments as follows.

FIG. 2 illustrates a flowchart of a depth information generation method of an image capturing device according to an embodiment of the disclosure, and the method in FIG. 2 may be implemented by the components of the image capturing device 100 in FIG. 1.

Referring to both FIG. 1 and FIG. 2, first, the image capturing module 122 of the image capturing device 100 would capture a scene by using the first lens 110a and the second lens 110b to respectively generate a first image and a second image of the scene (Step S202). To be specific, the first image and the second image are two images of the same scene captured from two different viewing angles respectively by the first lens 110a and the second lens 110b of the image capturing module 122, and could be, for example, live-view images captured in a preview status. Herein, the first lens 110a and the second lens 110b may capture images with same parameters, where the parameters include focal length, aperture, shutter, white balance, and so forth. The disclosure is not limited herein.

Next, the feature point detecting module 124 would detect first feature points and second feature points respectively from the first image and the second image to calculate pixel offset information between the first image and the second image, and obtain a rotation angle between the first image and the second image accordingly (Step S204), where each of the first feature points has its corresponding second feature point.

To be specific, the feature point detecting module 124 may detect feature points from the first image and the second image by edge detection, corner detection, blob detection, or other feature detection algorithms. Next, the feature point detecting module 124 would compare the feature points detected from the first image and the second image to find out feature point sets from the first image and the second image according to color information of the feature points and their neighboring points. After the feature point detecting module 124 obtain the first feature point and the second feature point in each of the feature point sets after comparison, it would obtain their pixel coordinates in the first image and the second image and calculate the pixel offset information between the first image and the second image accordingly. Herein, the pixel offset information between the first image and the second image provides an indication of displacement of the first lens 110a and/or the second lens 110b.

To be specific, since the first image and the second image are images captured by the first lens 110a and the second lens 110b from different viewing angles, ideally, each of the first feature points in the first image and its corresponding second feature point in the second image would be projected to a same coordinate in a reference coordinate system after coordinate transformation. Otherwise, the feature point detecting module 124 would obtain an offset of each feature point sets for image alignment in the follow-up steps.

From another viewpoint, due to the arrangement of the first lens 110a and the second lens 110b, ideally, there would only exist horizontal disparity or vertical disparity between the first image and the second image. Assume that the first lens 110a and the second lens 110b are left and right lenses disposed on a same image plane. In this case, there would only exist horizontal differences between the first image and the second image. Hence, if there exist vertical differences between the feature point sets in the first image and the second image, the feature point detecting module 124 would obtain a vertical offset of each of the feature point sets for image alignment in the follow-up steps.

In general, when displacement occurs to lenses, rotation would also occur thereto. Therefore, after the feature point detecting module 124 obtains the pixel coordinates and the pixel offset information of the first image and the second image, it would further calculate the rotation angle therebetween to obtain rotation level(s) of the first lens 110a and/or the second lens 110b.

Next, the image warping module 126 would perform image warping on the first image and the second image according to the pixel offset information and the rotation angle to respectively generate a first reference image and a second reference image, where the first reference image and the second reference image are aligned to each other (Step S206). In other words, the image warping module 126 would calibrate the image coordinates of the first image and/or the second image according to the pixel offset information and the rotation angle so that the calibrated images are aligned with each other. That is, the first reference image and the second reference image would be projected to same coordinates in a reference coordinate system after coordinate transformation. From another viewpoint, assume that the first lens 110a and the second lens 110b are left and right lenses disposed on a same image plane. In such case, there would only exist horizontal disparity in the first reference image and the second reference image after image warping.

Next, the depth calculating module 128 would perform three-dimensional depth estimation by using the first reference image and the second reference image to generate depth information of the scene (Step S208). To be specific, the depth calculating module 128 would perform stereo matching on each pixel in the first reference image and the second reference image to obtain the depth information corresponding to each of the pixels. The depth calculating module 128 could further store the depth information in, for example, a depth map for more application in image processing.

Moreover, in another embodiment, when the first lens 110a and the second lens 110b are different, the image capturing device 100 could further include an image adjusting module (not shown) to adjust the first image and the second image. For example, when the resolution of the first image and that of the second image are different, after the image capturing module 122 captures the first image and the second image in Step S202, the image adjusting module could adjust the first image and the second image so that the resolutions of the two images become the same for more precise detection and calculation in the follow-up steps.

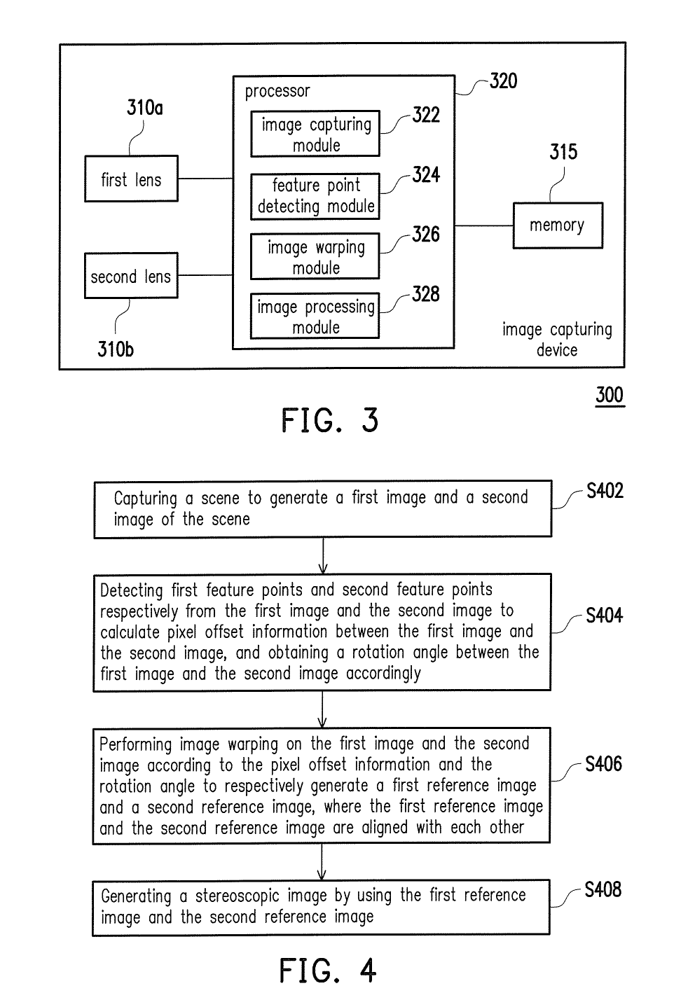

FIG. 3 illustrates a block diagram of an image capturing device according to another embodiment of the disclosure. It should, however, be noted that this is merely an illustrative example and the invention is not limited in this regard.

Referring to FIG. 3, an image capturing device 300 includes a first lens 310a, a second lens 310b, a memory 315, and one or more processors 320 respectively similar to the first lens 110a, the second lens 110b, the memory 115, and the processor 120. Detailed description may refer to the aforementioned related paragraphs and would not be repeated hereafter. The processor 320 of the image capturing device 300 includes an image capturing module 322, a feature point detecting module 324, an image warping module 326, and an image processing module 328 to perform real-time auto-calibration on images captured by the image capturing device 300. Detail steps of the auto-calibration method performed by the image capturing device 300 would be illustrated by the embodiments as follows.

FIG. 4 illustrates a flowchart of an auto-calibration method of an image capturing device according to an embodiment of the disclosure, and the method in FIG. 4 may be implemented by the components of the image capturing device 300 in FIG. 3.

First, the image capturing module 322 of the image capturing device 300 would capture a scene by using the first lens 310a and the second lens 310b to respectively generate a first image and a second image of the scene (Step S402). Next, the feature point detecting module 324 would detect first feature points and second feature points respectively from the first image and the second image to calculate pixel offset information between the first image and the second image, and obtain a rotation angle between the first image and the second image accordingly (Step S404). Next, the image warping module 326 would perform image warping on the first image and the second image according to the pixel offset information and the rotation angle to respectively generate a first reference image and a second reference image, where the first reference image and the second reference image are aligned with each other (step S406). The processing approaches of Steps S402, S404, and S406 may refer to the related description of Steps S202, S204, and S206 and would not be repeated hereafter.

Next, the image processing module 328 would generate a stereoscopic image of the scene by using the first reference image and the second reference image (Step S408). In the present embodiment, after the first reference image and the second reference image are aligned with each other, the image processing module 328 would directly output the first reference image and the second reference image as the stereoscopic image. In another embodiment, the image processing module 328 may further adjust parameters (e.g. color and brightness) of the first reference image and/or the second reference image to generate two images with matching color and brightness and thereby generate a natural and coherent stereoscopic image.

Similar to the embodiment in FIG. 2, the image capturing device 300 may further include an image adjusting module (not shown) with same functionalities as the image adjusting module of the image capturing device 100.

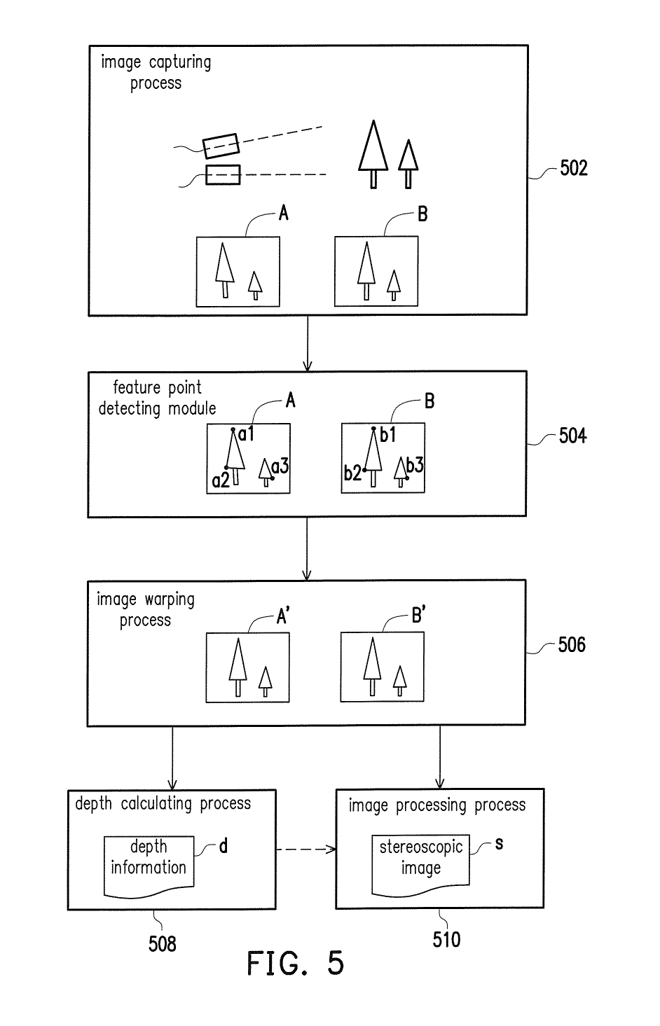

The aforementioned depth information generation method and the aforementioned auto-calibration method may be summarized by a functional block diagram as illustrated in FIG. 5 according to an embodiment of the disclosure.

First, in an image capturing procedure 502, a scene would be captured by using dual-lenses to respectively generate a first image A and a second image B. Next, in a feature point detecting procedure 504, feature point sets would be detected from the first image A and the second image B to calculate pixel offset information and a rotation angle between the first image A and the second image B, where feature points a1-a3 respectively correspond to feature points b1-b3. In an image warping process 506, a first reference image A′ and a second reference image B′ aligned with each other would be generated according to the pixel offset information and the rotation angle between the first image A and the second image B.

In an embodiment, after the first reference image A′ and the second reference image B′ are generated, depth information d of the scene would be calculated accordingly in a depth calculating procedure 508.

In another embodiment, after the first reference image A′ and the second reference image B′ are generated, a stereoscopic image s would be generated accordingly in an image processing procedure 510.

In yet another embodiment, the image processing procedure 610 may be performed after the depth calculating procedure 608. That is, the depth information d may be used as a basis to generate the stereoscopic image s. From another viewpoint, the present embodiment could be viewed as an integration of the image capturing device 100 and the image capturing device 300.

In summary, in the image capturing device, the depth information generation method and the auto-calibration method thereof proposed in the disclosure, after the image capturing device captures two images by using dual lenses, the two images are aligned according to pixel offset information and a rotation angle between the two images obtained through feature point detection, and depth information of a captured scene would be obtained and a stereoscopic image would be generated accordingly. The proposed image capturing device would generate depth information of captured scene and generate an auto-calibrated stereoscopic image in real time without pre-alignment by a module manufacturer so as to save up a huge amount of manufacturing cost.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A depth information generation method, adapted to an image capturing device having a first lens and a second lens without pre-alignment, comprising:
capturing a scene by using the first lens and the second lens to respectively generate a first image and a second image of the scene;
detecting a plurality of first feature points from the first image and a plurality of second feature points from the second image to calculate pixel offset information between the first image and the second image, and obtaining a rotation angle between the first image and the second image accordingly, wherein the first feature points correspond to the second feature points;
performing image warping on the first image and the second image according to the pixel offset information and the rotation angle to respectively generate a first reference image and a second reference image, wherein the first reference image and the second reference image are aligned with each other; and
calculating depth information of the scene according to the first reference image and the second reference image.

2. The method according to claim 1, wherein the step of detecting the first feature points from the first image and the second feature points from the second image to calculate the pixel offset information between the first image and the second image comprises:
detecting a plurality of feature points from the first image and the second image;
comparing each of the feature points in the first image and the second image to obtain a plurality of feature point sets, wherein each of the feature point sets comprises each of the first feature points and the second feature point corresponding to each of the first feature points; and
obtaining a pixel coordinate of each of the first feature points in the first image and a pixel coordinate of each of the second feature points in the second image to accordingly calculate the pixel offset information between the first image and the second image.

3. The method according to claim 2, wherein the step of obtaining the rotation angle between the first image and the second image comprises:
calculating the rotation angle between the first image and the second image according to the pixel coordinates and the pixel offset information of each of the first feature points and each of the second feature points respectively in the first image and the second image.

4. The method according to claim 2, wherein the step of performing image warping on the first image and the second image according to the pixel offset information and the rotation angle to respectively generate the first reference image and the second reference image comprises:
calibrating the pixel coordinates of at least one of the first image and the second image according to the pixel offset information and the rotation angle to respectively generate the first reference image and the second reference image.

5. The method according to claim 1, wherein the step of calculating the depth information of the scene according to the first reference image and the second reference image comprises:
performing three-dimensional depth estimation by using the first reference image and the second reference image to generate the depth information of the scene.

6. The method according to claim 1, wherein when a resolution of the first image is not the same as that of the second image, after the step of generating the first image and the second image of the scene, the method further comprises:
adjusting at least one of the resolution of the first image and that of the second image so that the resolution of the first image becomes the same as that of the second image.

7. The method according to claim 1, wherein the first lens and the second lens have different optical characteristics or different resolutions.

8. The method according to claim 1, wherein the first lens and the second lens have same optical characteristics or same resolutions.

9. An auto-calibration method, adapted to an image capturing device having a first lens and a second lens without pre-alignment, comprising:
capturing a scene by using the first lens and the second lens to respectively generate a first image and a second image of the scene;
detecting a plurality of first feature points from the first image and a plurality of second feature points from the second image to calculate pixel offset information between the first image and the second image, and obtaining a rotation angle between the first image and the second image accordingly, wherein the first feature points correspond to the second feature points;
performing image warping on the first image and the second image according to the pixel offset information and the rotation angle to respectively generate a first reference image and a second reference image, wherein the first reference image and the second reference image are aligned with each other; and
generating a stereoscopic image of the scene by using the first reference image and the second reference image.

10. The method according to claim 9, wherein the step of detecting the first feature points from the first image and the second feature points from the second image to calculate the pixel offset information between the first image and the second image comprises:
detecting a plurality of feature points from the first image and the second image;
comparing each of the feature points in the first image and the second image to obtain a plurality of feature point sets, wherein each of the feature point sets comprises each of the first feature points and the second feature point corresponding to each of the first feature points; and
obtaining a pixel coordinate of each of the first feature points in the first image and a pixel coordinate of each of the second feature points in the second image to accordingly calculate the pixel offset information between the first image and the second image.

11. The method according to claim 10, wherein the step of obtaining the rotation angle between the first image and the second image comprises:
calculating the rotation angle between the first image and the second image according to the pixel coordinates and the pixel offset information of each of the first feature points and each of the second feature points respectively in the first image and the second image.

12. The method according to claim 10, wherein the step of performing image warping on the first image and the second image according to the pixel offset information and the rotation angle to respectively generate the first reference image and the second reference image comprises:
calibrating the pixel coordinates of at least one of the first image and the second image according to the pixel offset information and the rotation angle to respectively generate the first reference image and the second reference image.

13. The method according to claim 9, wherein when a resolution of the first image is not the same as that of the second image, after the step of generating the first image and the second image of the scene, the method further comprises:
adjusting at least one of the resolution of the first image and that of the second image so that the resolution of the first image becomes the same as that of the second image.

14. The method according to claim 9, wherein the first lens and the second lens have different optical characteristics or different resolutions.

15. The method according to claim 9, wherein the first lens and the second lens have same optical characteristics or same resolutions.

16. An image capturing device without pre-alignment by a module manufacturer comprising:
a first lens;
a second lens;
a memory, storing images captured by the first lens and the second lens; and
a processor, coupled to the first lens, the second lens, and the memory, and comprising a plurality of modules, wherein the modules comprise:
an image capturing module, capturing a scene by using the first lens and the second lens to respectively generate a first image and a second image of the scene;
a feature point detecting module, detecting a plurality of first feature points from the first image and a plurality of second feature points from the second image to calculate pixel offset information between the first image and the second image, and obtaining a rotation angle between the first image and the second image accordingly, wherein the first feature points correspond to the second feature points;
an image warping module, performing image warping on the first image and the second image according to the pixel offset information and the rotation angle to respectively generate a first reference image and a second reference image, wherein the first reference image and the second reference image are aligned with each other; and
an image processing module, generating a stereoscopic image of the scene by using the first reference image and the second reference image.

17. The image capturing module according to claim 16 further comprising:
an image adjusting module, when a resolution of the first image is not the same as that of the second image, adjusting at least one of the resolution of the first image and that of the second image so that the resolution of the first image becomes the same as that of the second image.

18. The image capturing module according to claim 16 further comprising:
a depth calculating module, calculating depth information of the scene according to the first reference image and the second reference image.

19. The method according to claim 16, wherein the first lens and the second lens have different optical characteristics or different resolutions.

20. The method according to claim 16, wherein the first lens and the second lens have same optical characteristics or same resolutions.
